(19) United States
(12) Patent Application Publication
(10) Pub. No.: US 2020/0128624 A1
(43) Pub. Date: Apr. 23, 2020

(54) Temperature Control Tape and System for Vehicle Bodies

(71) Applicant: Anatoly Loegering, Sartell, MN (US)

(72) Inventor: Anatoly Loegering, Sartell, MN (US)

(21) Appl. No.: 16/166,844

(22) Filed: Oct. 22, 2018

(51) Int. Cl. H05B 1/02; H05B 3/03; H05B 3/34

(52) U.S. Cl. CPC H05B 1/0236; B60S 1/66; H05B 3/34; H05B 3/03

(57) ABSTRACT

A temperature control system for a vehicle body includes a temperature control tape disposed adjacent weather exposed surfaces of the vehicle body in a circuit network configured to uniformly control a temperature on the vehicle body surfaces. Repeater pads are connected by the temperature control tape. The repeater pads are engineered to generate a temperature difference in relation to an ambient temperature of an air surrounding the vehicle body. A temperature control fluid with a high specific heat is brought to a predetermined temperature and circulated through the control tape circuits by the repeater pads. A timer is configured to start and stop a circulation of the temperature control fluid. The temperature control tape is inlaid in the surfaces of the vehicle body or overlaid on the surfaces of the vehicle body and is magnetic or formed into the vehicle body at the time of original manufacture in various patterns.

### BACKGROUND

It is a frustrating thing to have to clean off or dig out a car from under a snowstorm. Not only does it take brushes and scrappers and time out in the cold weather but it is also a safety hazard. Resistive elements are common for windows and windshields when a car is in operation but do not help on the rest of the vehicle or when the vehicle is stationary. There have been no products available as original equipment or as an aftermarket to address this problem.

It is also dangerous in hotter climates to touch the top of a car that has been out in the sun for several hours. Hot roofs on vehicles create hot interiors not to mention the oxidation damage that sunlight creates on the paint of a vehicle on a hot day. Car covers do not really make a temperature change to the car underneath and therefore do not solve the temperature problem. Taking a car to a car wash on a hot day can also crack a glass window due to the temperature difference. There have been no products available as original equipment or as an aftermarket to address this problem either.

There exists a need for a device and a system for temperature control of an outside of a vehicle that is not being met by any known or disclosed device or system of present.

### SUMMARY OF THE INVENTION

The temperature control system for a vehicle body includes a temperature control tape disposed adjacent a plurality of weather exposed surfaces of the vehicle body in a serpentine circuit network configured to uniformly control a temperature on the vehicle body surfaces including the roof, both sides, the front and the back. Repeater pads are connected by the temperature control tape. The repeater pads are engineered to generate a temperature difference in relation to an ambient temperature of an air surrounding the vehicle body. A temperature control fluid with a high specific heat is brought to a predetermined temperature and circulated through the control tape circuit network by the repeater pads. Vehicle body edges such as the door edges cause a barrier to the temperature control tape. Repeater pads enable the circuit network to continue or bridge the door edges.

A temperature control method disclosed for a vehicle body includes disposing a temperature control tape adjacent weather exposed surfaces of the vehicle body in a circuit configured to uniformly control a temperature on the vehicle body surfaces. The method also includes connecting a plurality of repeater pads by the temperature control tape. The repeater pads generate a temperature difference in relation to an ambient temperature of an air surrounding the vehicle body. The method further includes circulating a temperature control fluid having a high specific heat brought to a predetermined temperature through the control tape circuit by the plurality of repeater pads.

### BRIEF DESCRIPTION OF THE DRAWINGS

FIG. 1 is a side elevational view of a generic vehicle and the Temperature Control Tape and System in accordance with an embodiment of the present disclosure.

FIG. 2 is a top elevational view of a generic vehicle and the Temperature Control Tape and System in accordance with an embodiment of the present disclosure.

FIG. 3 is a back elevational view of a generic vehicle and the Temperature Control Tape and System in accordance with an embodiment of the present disclosure.

FIG. 4 is a front elevational view a generic vehicle and the Temperature Control Tape and System in accordance with an embodiment of the present disclosure.

FIG. 5 is a perspective view of an end of the temperature control tape in accordance with an embodiment of the present disclosure.

FIG. 6 is a schematic view of a serial and a parallel repeater pad in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘repeater pad’ is used to refer to serial or parallel modules which are engineered to boast, improve or to recreate a signal strength including providing power and ground and heat and cold fluids depending on the design parameters. The term ‘temperature control’ refers to an ability to adjust and maintain a temperature of a vehicle body in relation to an ambient air temperature surrounding the vehicle.

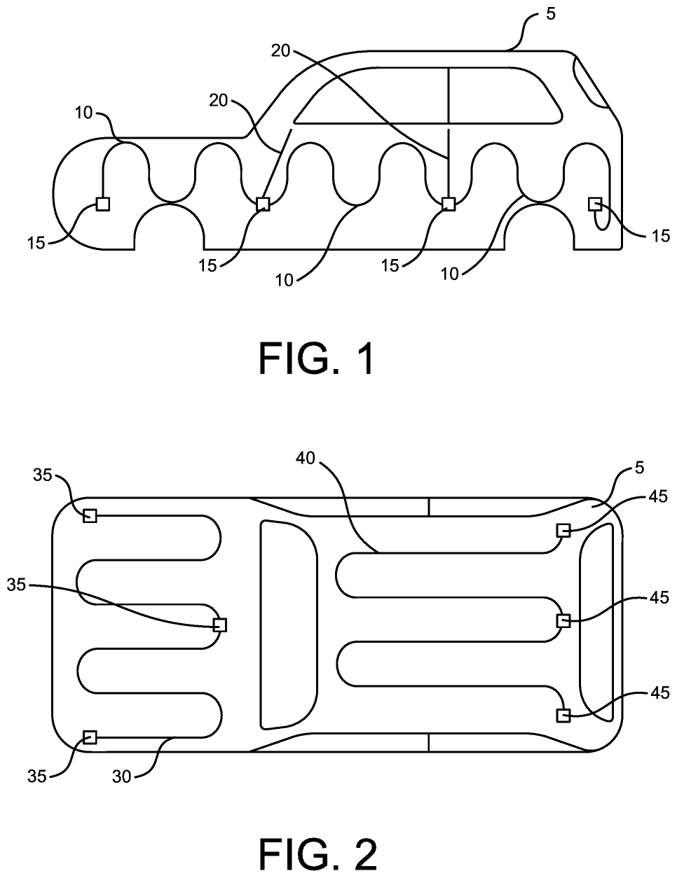

FIG. 1 is a side elevational view of a generic vehicle and the Temperature Control Tape and System in accordance with an embodiment of the present disclosure. The temperature control system for a vehicle body 5 includes a temperature control tape 10 disposed adjacent a plurality of weather exposed surfaces of the vehicle body 5 in a serpentine circuit network configured to uniformly control a temperature on the vehicle body 5 surfaces including the roof, both sides, the front and the back. Repeater pads 15 are connected by the temperature control tape 10. The repeater pads 15 are engineered to generate a temperature difference in relation to an ambient temperature of an air surrounding the vehicle body 5. A temperature control fluid with a high specific heat is brought to a predetermined temperature and circulated through the control tape 10 circuit network by the repeater pads 15. Vehicle body edges such as the door edges 20 cause a barrier to the temperature control tape 10. Repeater pads 15 enable the circuit network to continue or bridge the door edges 20. Other patterns such as a saw tooth or a random meandering pattern are also disclosed for coving the vehicle body 5 in the temperature control tape 10.

In an embodiment of the disclosure, a timer is configured to start and stop a circulation of the temperature control fluid. An intensity level or temperature range are also specified by electronic control. Depending on when the temperature control tape 10 is applied to the vehicle body 5, the control tape 10 is inlaid in the surfaces of the vehicle body 5 or overlaid on the surfaces of the vehicle body 5. The temperature control tape is magnetic in some embodiments magnetically sticks on the surfaces of the vehicle body 5. In other embodiments, the temperature control tape 10 is formed into the vehicle body 5 at the time of original manufacture.

The temperature difference of the repeater pads 15 is hotter or colder in relation to an ambient temperature of an air surrounding the vehicle body. The network engineered to uniformly control a temperature on the vehicle body 5 surfaces is configured in a serpentine pattern, a saw tooth pattern, a grid pattern, a winding pattern, a random meandering pattern and any other pattern which covers the vehicle body surface. The repeater pads are powered by solar cells on the surface of the vehicle body and by electric battery cells located in the vehicle body.

FIG. 2 is a top elevational view of a generic vehicle and the Temperature Control Tape and System in accordance with an embodiment of the present disclosure. Temperature control tape 30 is connected by repeater pads 35 on a hood of the vehicle 5 for a first circuit. Temperature control tape 40 is connected by repeater pads 45 on a roof of the vehicle 5 for a second circuit. Electronic control of the first and second circuits is operated by a driver or passenger of the vehicle or is set by an automated processor.

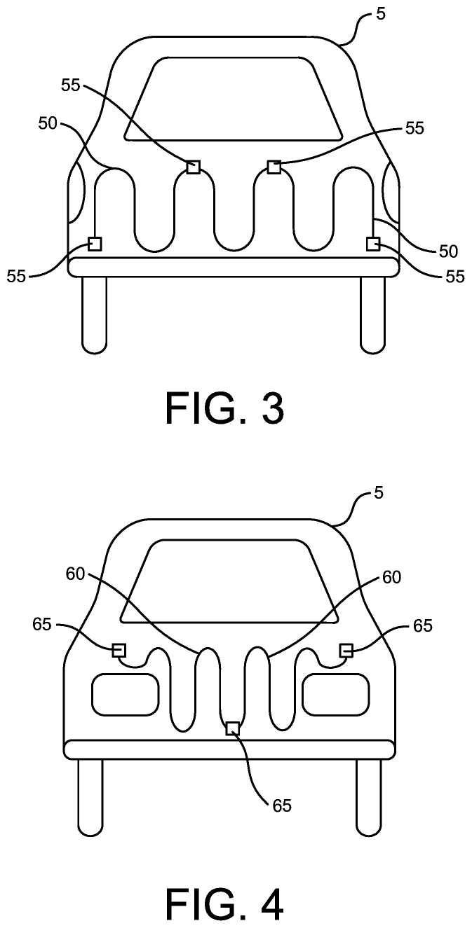

FIG. 3 is a back elevational view of a generic vehicle and the Temperature Control Tape and System in accordance with an embodiment of the present disclosure. Temperature control tape 50 is connected by repeater pads 55 on the rear end of the vehicle 5. Other patterns, though not depicted are also included in the disclosure. A distance between repeater pads 55 is set in a heating aspect by a resistive property of the temperature control tape. A voltage drop over a distance falling below a threshold prompts a repeater placement to boost the voltage. Similarly, a drop rise in temperature for a cooling effect prompts a repeater pad placement to replace hot fluid with a cooler fluid for circulation on the vehicle surface.

FIG. 4 is a front elevational view a generic vehicle and the Temperature Control Tape and System in accordance with an embodiment of the present disclosure. Temperature control tape 60 is connected by repeater pads 65 on the front hood of the car. Three repeater pads are indicated but a larger number of pads or a smaller number of pads are used in embodiments in order to have a greater control over the granularity of the temperature control desired. In other words, more temperature control pads afford a greater temperature difference between the ambient air temperature and the desired temperature of the vehicle body. Likewise, more available power per heat pad also enables a bigger temperature delta.

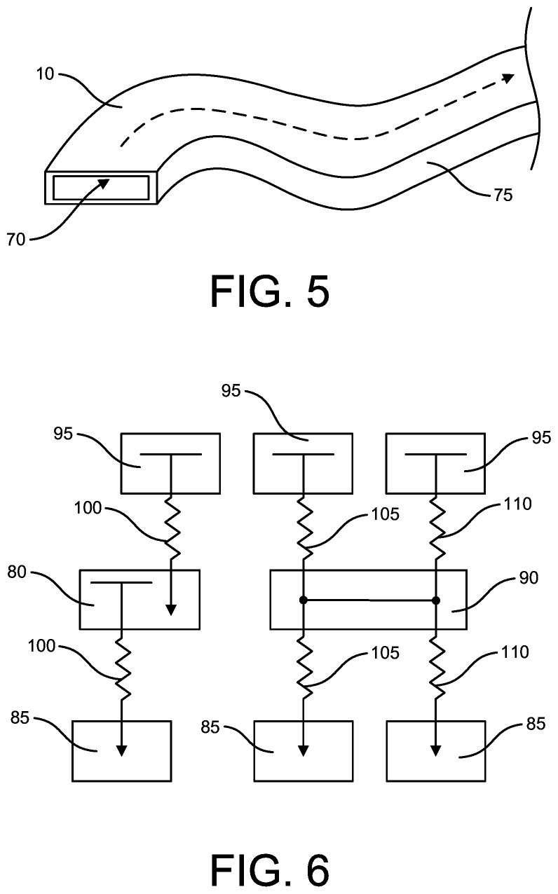

FIG. 5 is a perspective view of an end of the temperature control tape in accordance with an embodiment of the present disclosure. An end of the temperature control tape 10 is conduit opening 70 through which the temperature control fluid is circulated such as Freon and other cooling fluids. The dual durometer composition of the temperature control tape 10 is indicated by both a flexibility and a hardness desired. A sidewall 75 depicts a conduit nature of the temperature control tape 10. The temperature control tape is also resistive for electric heat generation in an embodiment of the present disclosure.

FIG. 6 are schematic views of serial and parallel repeater pads in accordance with an embodiment of the present disclosure. Power source 95 provides an electric current or a cooling fluid according to a predetermined temperature difference desired in relation to an ambient temperature surrounding the vehicle 5. The repeater pad 80 is a serial repeater pad providing both a source of power and a ground source for the circuit network of temperature control tape 100. Repeater pad 90 is a connective repeater between temperature control tape circuit network 105 and 110 in a grid implementation and does not provide a power source or a ground source. The resistive characteristic of the temperature control tape 100, 105 and 110 is an electrical resistance and also a heat flow resistance in temperature control fluid implementations.

A temperature control method for a vehicle body includes disposing a temperature control tape adjacent weather exposed surfaces of the vehicle body in a circuit configured to uniformly control a temperature on the vehicle body surfaces. The method also includes connecting a plurality of repeater pads by the temperature control tape. The repeater pads generate a temperature difference in relation to an ambient temperature of an air surrounding the vehicle body. The method further includes circulating a temperature control fluid having a high specific heat brought to a predetermined temperature through the control tape circuit by the plurality of repeater pads.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A temperature control system for a vehicle body, comprising:
a temperature control tape disposed adjacent a plurality of weather exposed surfaces of the vehicle body in a network configured to uniformly control a temperature on the vehicle body surfaces; and
a plurality of repeater pads connected by the temperature control tape, the repeater pads configured to generate a temperature difference in relation to an ambient temperature of an air surrounding the vehicle body.

2. The system of claim 1, further comprising a temperature control fluid having a high specific heat brought to a predetermined temperature and circulated through the control tape network by the plurality of repeater pads.

3. The system of claim 1, further comprising a timer configured to start and stop a circulation of the temperature control fluid.

4. The system of claim 1, wherein the repeater pads provide a serial repeater of the temperature difference in a continuous network pattern and provide a parallel repeater for the temperature difference in a grid network pattern.

5. The system of claim 1, wherein the temperature control tape is inlaid in the surfaces of the vehicle body.

6. The system of claim 1, wherein the temperature control tape is overlaid on the surfaces of the vehicle body.

7. The system of claim 1, wherein a portion of the temperature control tape is magnetic and magnetically sticks on the surfaces of the vehicle body.

8. The system of claim 1, wherein the temperature control tape is formed into the vehicle body at the time of original manufacture.

9. The system of claim 1, wherein the temperature difference of the repeater pads is hotter in relation to an ambient temperature of an air surrounding the vehicle body.

10. The system of claim 1, wherein the temperature difference of the repeater pads is cooler in relation to an ambient temperature of an air surrounding the vehicle body.

11. The system of claim 1, wherein the network configured to uniformly control a temperature on the vehicle body surfaces is configured in a serpentine pattern.

12. The system of claim 1, wherein the network configured to uniformly control a temperature on the vehicle body surfaces is configured in a saw tooth pattern.

13. The system of claim 1, wherein the network configured to uniformly control a temperature on the vehicle body surfaces is configured in a grid pattern.

14. The system of claim 1, wherein the repeater pads are powered by solar cells on the surface of the vehicle body.

15. The system of claim 1, wherein the repeater pads are powered by electric battery cells located in the vehicle body.

16. A temperature control method for a vehicle body, comprising:
disposing a temperature control tape adjacent a plurality of weather exposed surfaces of the vehicle body in a circuit configured to uniformly control a temperature on the vehicle body surfaces; and
connecting a plurality of repeater pads by the temperature control tape, the repeater pads configured to generate a temperature difference in relation to an ambient temperature of an air surrounding the vehicle body.

17. The method of claim 16, further comprising circulating a temperature control fluid having a high specific heat brought to a predetermined temperature through the control tape circuit by the plurality of repeater pads.

18. The method of claim 16, wherein the circuit configured to uniformly control a temperature on the vehicle body surfaces is configured in a winding pattern.

19. The system of claim 16, wherein the circuit configured to uniformly control a temperature on the vehicle body surfaces is configured in a random meandering pattern.

20. A temperature control system, comprising:
a temperature control tape disposed adjacent a plurality of weather exposed surfaces of a vehicle body in a circuit network configured to uniformly control a temperature of the vehicle body;
a plurality of repeater pads connected by the temperature control tape, the repeater pads configured to generate a temperature difference in relation to an ambient temperature of an air surrounding the vehicle body; and
a temperature control fluid having a high specific heat brought to a predetermined temperature and circulated through the control tape network by the plurality of repeater pads.
